(19) United States
(12) Patent Application Publication
(10) Pub. No.: US 2007/0118993 A1
(43) Pub. Date: May 31, 2007

(54) Inflatable incontinence bed pad

(76) Inventor: Jason Bates, Crescent City, CA (US)

Correspondence Address: Jason Bates, 752 Pacific Ave, Crescent City, CA, 95531, US

(21) Appl. No.: 11/606,311

(22) Filed: Nov. 28, 2006

Related U.S. Application Data
(60) Provisional application No. 60/740,421, filed on Nov. 28, 2005.

(51) Int. Cl. A61G 9/00; A47C 27/10

(52) U.S. Cl. 5/655.3; 5/695; 5/630

(57) ABSTRACT

An incontinence bed pad comprised of one or more inflatable pads and one or more absorbent pads for use under a patient on a bed. The inflatable incontinence bed pad serves to spread pressure over an increased area for the patient to prevent or treat bed wounds. The inflatable pad may channel or drain fluids such as urine into the absorbent pad below, keeping the surface and patient dry. Alternately, the absorbent pad may be placed above the inflatable pad to reduce cleaning work. The one or more air bladders are inflatable through one or more ports. The ports pass air from one or more manual or powered air pumps to the one or more air bladders. Making an incontinence pad of an inflatable nature offers advantages not available in the prior art. The inflation and deflation of distinct sealed chambers or zones within the inflatable pad may tilt a patient's hips to the right and to the left periodically. The pad may inflate in a static position. The pad may inflate and deflate zoned areas to alternate pressure areas of the patient. Inflating and deflating areas of the pad may push waste away from the person. The inflated pad may leak air to wick moisture and heat from a patient. Handles may be integrated to the inflatable incontinence bed pad for transferring the patient on and off the bed and to other places. Straps compatible with a patient lift system may be integrated. This could reduce work and injury to care providers, as well as reducing disruption to the patient. Side rails may be integrated for safety.

### BACKGROUND OF THE INVENTION

(i) Field of the Invention

This invention relates in general to an inflatable incontinence bed pad, in particular, the invention relates to an incontinence bed pad utilized for bed wound prevention and treatment as well as adding features to benefit care providers.

(ii) Description of the Related Art

This invention relates to incontinence pads used on beds. Incontinence pads in use today are typically made of cotton or some absorbent material. In many cases two or more may be used under a patient in order to soak up bodily fluids such as urine and to separate the waste from the bed. The existing pads do not provide any additional support for the patient on a bed.

By making an incontinence pad of inflatable form, the incontinence pad goes from being two-dimensional to being three-dimensional. Since a person's body has three-dimensional contours, it follows that the inflatable bed pad can offer a person support over a larger surface area of the body, thereby reducing pressure spots.

Patients typically lay in the wet absorbent pads after urinating, increasing the likelihood of skin maceration (over-hydration) and infection of wounds. The standard absorbent two dimensional incontinence bed pad uses its area to soak up fluids. To increase the amount of fluids absorbed, the area of the pad must increase. As the area of the pad increases, the area of the patient's skin in contact with the absorbent pad also increases. An inflatable incontinence bed pad is three-dimensional and can therefore use its volume to absorb fluids. Inflating and deflating areas of the pad may push waste away from the person. An incontinence pad of a three dimensional nature may also utilize the high and low areas of the pad to channel fluids down away from the patient above. The fluids may drain through the low areas of the pad, into an absorbent pad beneath.

The prior art of incontinence bed pad designs include variations on bedpans. These include U.S. Pat. No. 5,640,728 to Grabe, U.S. Pat. No. 4,965,900 to Smith, U.S. Pat. No. 3,757,356 to Freeman, U.S. Pat. No. 3,089,153 to Bosc, and U.S. Pat. No. 1,769,482 to Allcutt. These share similar attributes. The receptacle feature requires a volume. The bedpan must either raise the height of the bed surface or be integrated into the mattress. If the inflatable incontinence bed pad is deflated, it lies flush with the bed but will still absorb fluids. The large receptacle openings for drainage may reduce the area for a patient to lay on, thereby increasing pressure areas. These systems cannot be used as a transfer pad or as a sling for use with a patient lift. Thorough cleaning may require disassembly. It is not possible to machine wash or to machine dry these devices. Some of the devices require cushions or upstanding pillars, unlike the inflatable incontinence bed pad. These devices do not work in conjunction with a standard absorbent incontinence pad. These devices require more resources to build and would likely be more expensive.

Those who are bed-bound for extended periods can suffer from bedsores. People can seek medical attention, and then find themselves unable to be discharged due to bedsores, even with the original ailment resolved. While in bed, a majority of a patient's weight exerts pressure on relatively small surface areas of the body, especially near the tailbone, or coccyx. These pressure areas collapse capillaries and starve the tissue of oxygen and nutrition. Prolonged wetness on the skin from sweat or from a wet incontinence bed pad can accelerate the breakdown of tissue, known as maceration. Body wastes collected on an incontinence bed pad in the vicinity of a bed sore can cause infection to wounds.

One of the least expensive attempts at prevention of bed wounds is the Alternating Pressure Pad, or APP. This is a vinyl mattress overlay comprised of two sheets of vinyl bonded together around a perimeter and in rows three to four inches wide from head to toe. An APP air pump alternates pumping air into every other row for the purpose of alternating the pressure areas for a patient. With every other row deflated, however, the patient is effectively lying on half as much surface area, and pressure may be increased in some cases. The vinyl material holds moisture in which can cause skin maceration. Reduced air circulation and heat build-up on the patient's skin may also be problems.

Inflatable ‘Low Air Loss’ mattresses are sometimes utilized to spread out pressure spots and to move moisture away from the patient with airflow. Such is the case with the moisture-drying mattress in U.S. Pat. No. 6,487,739 B1 to Harker. The standard absorbent incontinence pad is then often placed on top of the low air loss mattress and directly against the patient's skin. The incontinence pad not only blocks a majority of the low air loss benefit in critical areas; it also holds moisture against the very areas that need to be dry. By having the low air loss breathe out of the incontinence pad itself, the ensuing moisture wicking dryness and heat build-up prevention is directly against the patient's skin.

Low air loss and alternating pressure mattresses are cumbersome to store, move, and install. They are also very difficult to clean. Some nursing homes lease these mattresses so that the cleaning of them is outsourced. This creates extra work as a driver must deliver and pick up the mattresses. These types of mattresses have many parts that depend on one another for the mattress to function. If even one air cell deflates it can create discomfort for the patient and the care providers. The parts are specialized enough that it may require a repairperson to drive to the facility to fix a problem.

Options for the prevention or treatment of bed wounds such as low air loss moisture wicking, alternating pressure zones, and periodically tilting the user to one side or the other become possible with an inflatable incontinence bed pad. These systems can be made available with fewer resources, less expense, less weight, and air pumps using less energy than for what is required for an entire mattress. Storage, installation, and cleaning are easier as well.

U.S. Pat. Nos. 6,511,501 B1 and 6,102,936, both to Augustine et al. disclose an inflatable thermal pad for warming a patient with hypothermia. The pad has drainage holes and low air loss type holes. In this device the low air loss holes are for delivering warmed air to a hypothermic patient. The inflatable incontinence bed pad utilizes low air loss to wick moisture from bed wounds. The inflatable thermal pad serves the upper torso and head, unlike the inflatable incontinence bed pad, which serves the lower torso, hips, buttocks, and upper legs. The thermal pad is for short-term care while the inflatable incontinence bed pad is for long term care. The drainage functions in these two devices are intended for different fluids: the thermal pad's are intended for patients who are losing blood, while the inflatable incontinence bed pad's are intended primarily for urine.

The inflatable bed pad can offer side rails for safety, which may be made of foam and removable, or as part of the inflatable pad, or by some other method or material. This feature may be helpful in nursing homes, even for patients not at risk for bedsores.

Straps or handles may be added to the inflatable incontinence bed pad to aid caregivers in transferring a patient on and off of the bed. These may make the inflatable bed pad compatible with patient lifts, such as the Hoyer lift system. This would reduce strain to the caregivers and reduce disruption of the patient because no transfer pad or lift sling would have to be put under a patient. The drainage built in to the inflatable incontinence pad may make it possible to wash the patient and the inflatable incontinence pad itself without transferring the patient off of the inflatable incontinence pad.

Openings on one or more side for washing the inside of the inflatable pad may be closed airtight by rolling and fastening, by an airtight zipper or by some other method. This allows the inflatable incontinence bed pad to be thoroughly washed and dried inside and out by machine or by hand.

The inflatable incontinence bed pad can be integrated with the absorbent bed pads or as a separate pad that goes on top of or beneath the standard absorbent pads. Non standard absorbent pads may be used. A low shear cover may combine with the absorbent pad to form a pillow case type of enclosure for the inflatable pad. The low shear cover, inflatable pad, and absorbent pad may be snapped together, clipped together, zippered, not fastened together, or combined in a variety of combinations.

Utilizing the inflatable incontinence bed pad to tilt a patient's hips to the left and right sides periodically (‘turning’ a patient) has advantages to the patient and for care providers. Patients are typically turned by hand every 2 hours. This practice is proven to help in healing bed sores. Turning the patient rotates the tailbone so as to not point it into the mattress. The 2 hour time frame came from a war situation where care providers would start turning patients at one end of the room, and when every patient was turned, then start over. It took 2 hours per cycle. Capillaries can begin to collapse after 15 minutes of pressure, so having this task automated can keep a patient turning before the capillaries can collapse. It is not practical for care providers to turn a patient every 15 minutes. Care providers who turn patients and transfer patients have a poor record for lower back injuries. Automating the turning of patients can help to relieve some of this lower back workload. Periodic turning can also improve circulation for the patient and help to move any fluids in the lungs.

Air mattresses are available to turn a patient. They are very expensive, heavy, and have many parts that can fail. They turn the entire patient laterally. This can disrupt activities such as eating or watching TV. Utilizing the inflatable incontinence bed pad to tilt a patient's hips laterally has the advantage of not moving the upper torso and head. The areas most prone to bed wounds are near the coccyx and that is the area the inflatable incontinence pad most benefits.

In a power outage, Low Air Loss mattresses will deflate and the patient will sink into a thin pad of air or foam lying on top of the bed frame. This is unhelpful to the prevention or treatment of bed wounds and can scare a patient. Caregivers are often busy during a power outage and cannot attend as well to a patient's safety and comfort. The inflatable incontinence bed pad had the advantage that if it deflates, the patient remains lying on a regular mattress. Deflated, the low shear cover, transfer handles, side rails, and lift sling straps all still benefit the patient and care providers.

The inflatable pad can be made to work with standard absorbent incontinence pads, which would reduce expense and increase familiarity. The standard absorbent incontinence pads can be placed on top of the inflatable pad to reduce cleaning while maintaining benefits such as pressure reduction, alternating pressure, and/or regular tilting from side to side. If the patient requires more intensive measures, then the standard absorbent incontinence pads can be placed beneath the inflatable pad. This would allow fluids such as urine to drain underneath and be absorbed by the standard incontinence pads. A low shear cover with perforations can be used to filter solid waste from fluid waste. Low air loss and a low skin shear cover would also then be directly in contact with the patient.

In conclusion, this invention can improve care for a patient, reduce work and injuries for care providers, and save costs to care facilities and to the Medicare system as well.

### SUMMARY OF THE INVENTION

The invention, an inflatable incontinence bed pad, is placed under a patient in a bed. It is comprised of one or more inflatable pads and one or more absorbent pads. The absorbent pad(s) may be configured to be free to be moved beneath or above the inflatable pad(s). The inflatable pad may be made to channel or drain fluid to one or more absorbent pad(s) beneath.

The inflatable pad can be made of vinyl or urethane coated nylon or some other suitable material that is airtight to form an inflatable bladder. Two layers of such material may be bonded around a perimeter to be airtight. One or more flange valves or some other suitable connective device can be attached as a port for one or more air hoses to pump air in. The air hoses may pass air via a manual air pump or a powered air pump.

The air bladder may be sealed in various zones and these zones may be inflated or deflated over time to tilt the user or offer alternating pressure zones. The air bladder may have small holes to release air for the purposes of protecting the pad and the user from excessive air pressure or for patient benefits such as low air loss moisture wicking.

The air bladder may feature a cover that is comfortable to the user. The cover may combine with the absorbent bed pads to form a ‘pillow case’ type of cover for the inflatable portion. The cover may be sewn or clipped or zippered or fastened in some other manner to the air bladder. The cover may have a type of ‘poly-fill’ such as Dacron to cushion the pressure points and to diffuse any moisture wicking low air loss. The cover may have an area similar to the absorbent incontinence pads or it may be in the form of a fitted bed cover sheet, or some other area.

The inflatable incontinence pad may have straps integrated to make the bed pad compatible with patient lifts, such as the Hoyer lift system. The straps may serve as transfer pad handles.

The pad may offer side rails for safety. The side rails may be inflated zones of the air bladder or attachments made of foam or some other material, device or method.

### BRIEF DESCRIPTION OF THE DRAWING

FIG. 1 is a perspective, exploded view of the inflatable incontinence pad.

FIG. 2 is a perspective view of the inflatable incontinence pad, inflated to tilt a patient's hips up on their right side.

FIG. 3A is a perspective view of the inflatable pad, inflated, without a cover.

FIG. 3B is a perspective view of the inflatable incontinence pad with straps for a patient lift, shown with the inflatable pad and cover lifted, and with the absorbent pad remaining on the mattress.

FIG. 4A is a perspective view of the inflatable pad, without a cover, showing a port for washing inside the inflatable pad with the said port rolled up airtight.

FIG. 4B is a perspective view of the inflatable pad, without a cover, showing a port rolled open for washing inside the inflatable pad.

FIG. 5 is a side sectional view along 3C-3C of FIG. 3A showing air loss holes and a fluid channel drain hole.

### DETAILED DESCRIPTION OF THE PREFERRED EMBODIMENTS

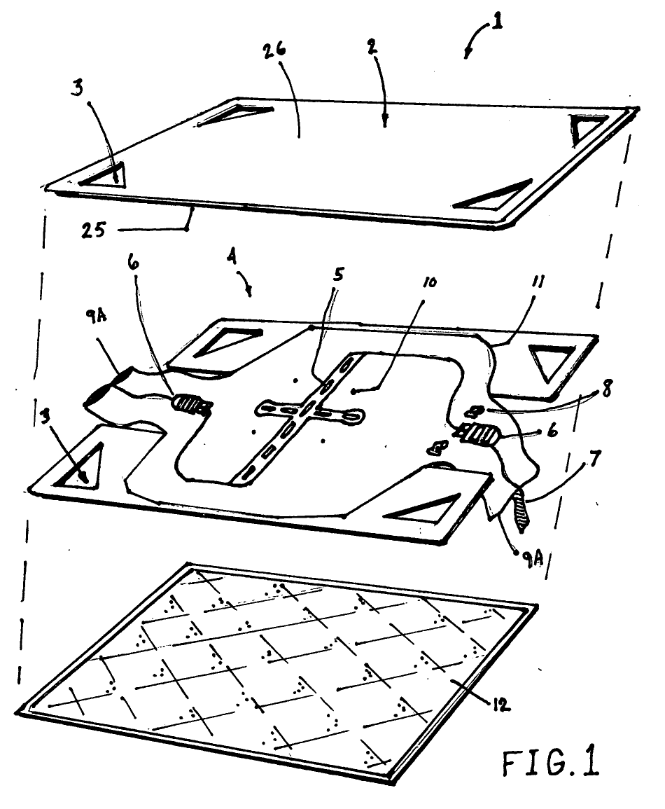

FIG. 1 shows an exploded view of three main components of the preferred embodiment of the inflatable incontinence pad 1: a cover 2, an inflatable pad 4, and a standard absorbent incontinence pad 12.

A cover 2 may be made of a low friction top layer 26 and a layer underneath 25. The top layer may be made of nylon or some other suitable material. The layer beneath the top layer may be made of Dacron, poly-fill, or other suitable material. Preferred materials may disperse air from low air loss emitted by the inflatable layer. They will allow fluids to drain downward. They may not compress enough to block air circulation under pressure. The cover 2 may hold solid waste but allow fluids to pass through, like a filter. This feature is for keeping the patient on top of the cover dry. The top layer 26 may be perforated. The cover may have holes to form handles 3 that may combine with holes in the inflatable layer 4 to form handles 3. The cover 2 may be free to move atop of the inflatable layer 4 in order to form a low shear surface. The cover may be in one or more pieces, no cover may be used, or the cover may be integrated with a fitted bed sheet. In the preferred embodiment shown, it is to be sewn to the perimeter of the inflatable pad 4.

The inflatable layer 4 can be made of one or more air bladders. In the preferred embodiment shown, it is a single inflatable pad 4. It may be made of any suitable airtight material. It may be made from two layers of urethane-coated nylon, vinyl, Gore-Tex, or other material suitable for forming one or more air bladders. The two layers may be sealed 11 together around a perimeter. The two layers may be sealed into distinct zones. These zones may be inflated or deflated with air channels or air ports 8. Thus the zones may provide alternating pressure for the patient. In the preferred embodiment shown, the zones inflate to lift a patient's hips or body on one side 17.

One or more ports 9A may be left unsealed to allow for washing inside the inflatable bladder 4. The port(s) may be closed airtight by rolling a flap and holding the roll closed with a fastener 6 and a strap 7. Other methods for sealing the washing port may be used such as a waterproof zipper.

The inflatable layer 4 may have holes for handles 3 that may be combined with holes for handles 3 in the cover 2 for extra strength. The handles 3 may be reinforced by sewing nylon webbing or some other suitable material attached by a suitable method.

The inflatable bladder may channel fluids from a relatively high inflated portion to a lower portion such as a seam 11. The fluids may drain through drain holes 5, keeping the patient on top of the pad dry.

The inflatable pad 4 may utilize low air loss holes 10 for keeping the pad from over inflating or for wicking moisture from the cover 2, thereby drying a patient's skin and preventing maceration. The inflatable pad 4 may be inflated through one or more air ports 8 that may pass air to or from a manual or powered air pump 15 (not shown in FIG. 1).

Fluids pass through the cover 2 and are channeled through drain holes 5 in the inflatable pad 4. An absorbent incontinence pad 12 can absorb these fluids. The patient is separated from the wet incontinence pad 12 by the inflatable pad 4 and the cover 2. In the preferred embodiment shown, a standard incontinence pad is used to reduce costs and increase familiarity. The absorbent article may take other forms.

In some circumstances, the absorbent incontinence pad 12 may be placed on top of the cover 2 and the inflatable pad 4. The absorbent incontinence pad 12 would then be directly in contact with the patient. For example, if the patient's bed wounds are not serious and one wishes to avoid cleaning the cover 2 and the inflatable pad 4. In this case the patient could still receive the benefits of pressure reduction, alternating pressure, and tilting of the hips, while the caretaker may still utilize the transfer handles 3 and patient lift straps 18 (not shown in FIG. 1). In this case, urine and such matter would be absorbed by the incontinence pad 12, which is on top. This would leave the cover 2 and the inflatable pad 4 clean and dry.

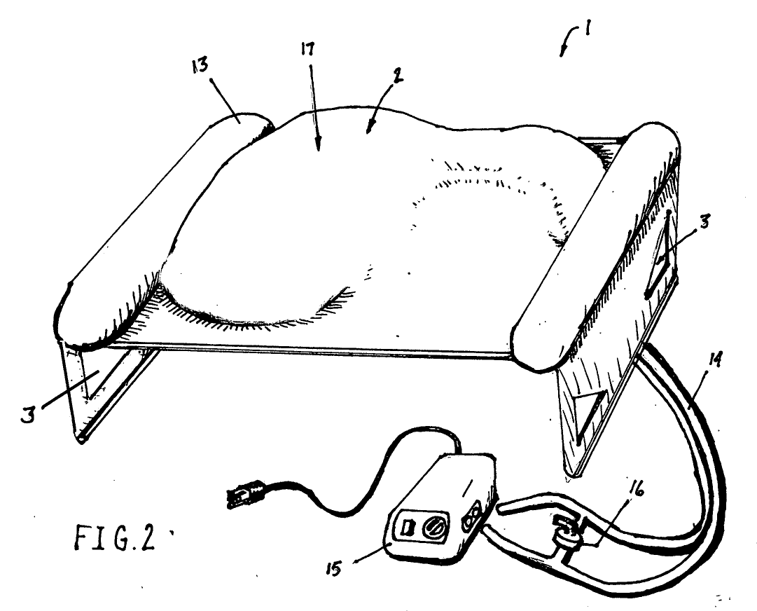

FIG. 2 shows the inflatable incontinence pad 1 inflated in such a way as to tilt a patient's hips 17 to the patient's left side. Side rails 13 are shown that are for providing extra safety in preventing a patient from falling out of bed. In a worst case scenario, if a patient falls with the pad, the side rails 13 may absorb some impact of the fall. The same may be true of the inflatable pad 4. The side rails 13 may be made of foam, or they may be made of air channels in the inflatable pad 4. They may be made by some other suitable method or materials. They may be fastened to or within the cover 2, the inflatable pad 4, the absorbent pad 12, or a combination of these or other parts.

FIG. 2 shows the sides of the inflatable incontinence pad having handles 3. The sides may drape down the sides of the mattress, which may assist in channeling moisture down away from a patient. Air hoses 14 are shown ready to pass air between an air pump 15 and the inflatable pad 4.

The pump shown is a standard Alternating Pressure Pad (APP) air pump 15. The model is shown in the preferred embodiment because it is already mass produced and common in nursing homes. This invention is not limited to using this particular air pump. This APP air pump 15 typically alternates pumping air out of one of two ports in cycles of five to ten minutes. In the preferred method shown, the air pump 15 alternates pumping air between the two ports on the pump and this air is passed to the inflatable incontinence pad 1 through the air hoses 14. The air hoses pass the air into the inflatable pad 4 (not shown in FIG. 2) through the air ports 8 (not shown in FIG. 2). One air port 8 can inflate the right side of the pad 17 while the other air port inflates the left side of the pad. In this configuration, as the APP air pump 15 cycles between its ports every five to ten minutes, the pad alternates inflating the left or right side every five to ten minutes. This causes tilting the patient's hips from side to side periodically. Configured differently the inflatable incontinence pad 1 could inflate in a static position, or it could alternate inflation and deflation zones in a number of different configurations and time cycles.

In the preferred method shown, a valve 16 is positioned between the two air hoses 14. When the valve 16 is closed, one hose 14 may be pressurized and passing air while the other hose 14 is not. With the valve opened all the way, it does not matter which of the two hoses 14 is pressurized and passing air because the air pressure will pass through the open valve 14 to the other hose 14 as well. Therefore, with the valve open, both hoses 14 will be pressurized and passing air to the inflatable pad 4 and in the preferred method shown, the hips will not be tilted side to side, rather the entire inflatable pad 4 will inflate equally and will be in a static state. Note that the low air loss holes 10 (not shown in FIG. 2) will still be emitting air in this static state. The valve 16 may be set in any position between open and closed. In an in-between setting, the valve 16 will cause the left and the right sides of the inflatable pad 4 to inflate, but one side will receive more pressure than the other. This will cause the patient's hip to tilt, up on the side with the higher pressure 17, but now the side with the lower pressure will be like a soft air pillow. This can be more comfortable to a patient because their hips are now tilted into a soft air pad and their pressure is further spread out over a wider surface area. Also in this case, low air loss holes 10 on both the right and the left sides of the inflatable bladder 4 will be emitting air.

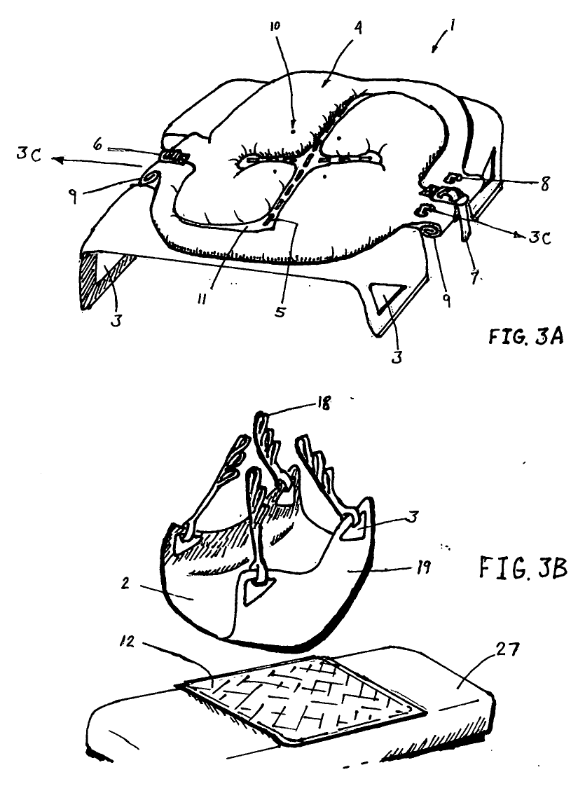

FIG. 3A shows the inflatable pad with no cover. The ports 9 for washing the inside of the air pad are rolled up air tight and fastened with fasteners 6, and straps 7. Flanged air ports 8 are attached. Holes for handles 3 are present. Drain holes 5 are shown. Possible positions for low air loss holes 10 are shown, although positions of these and any of the parts or seams 11 could be moved.

FIG. 3B shows one method of attaching straps 18 to the handles 3 for utilizing the inflatable incontinence pad 1 as a sling for a patient lift. Note that the absorbent pad 12 is still on the mattress. In this way, fluids may drain out of the top portion of the inflatable incontinence pad 1 into the absorbent pad 12 before the patient is moved, thereby avoiding fluids falling to the floor and making it wet and unsafe. The invention is not limited to this configuration. The straps 18 may be integrated as a part of the inflatable incontinence pad 1. They may not be utilized at all. The absorbent pad 12 may be attached to the top layer of the inflatable incontinence pad 1. The absorbent pad 12 may be placed on top of the cover 2 of the inflatable incontinence pad 1. Another configuration may also prove desirable.

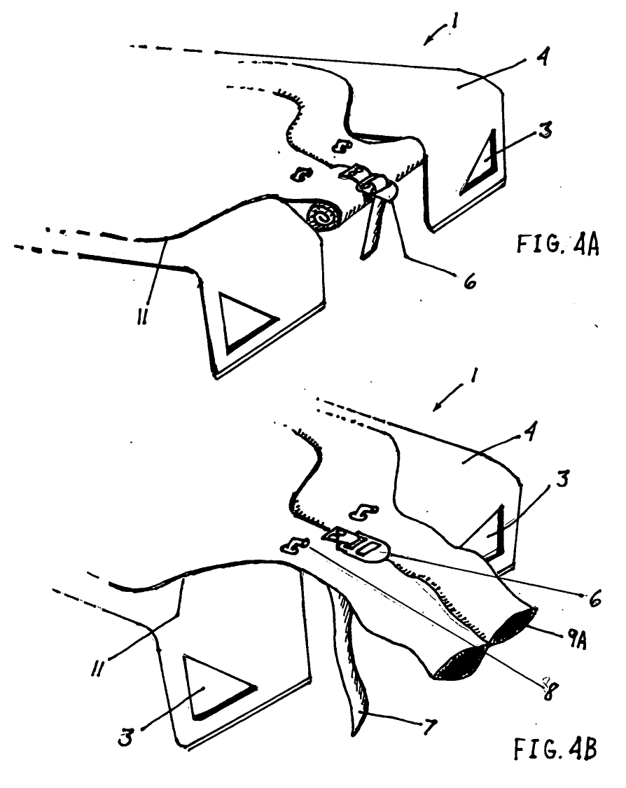

FIG. 4A shows one side of the inflatable pad 4 with the port for washing rolled up airtight 9 and held in place with a fastener 6 and a strap 7.

FIG. 4B shows the same view, but with the port rolled open for washing 9A the inside of the inflatable pad 4.

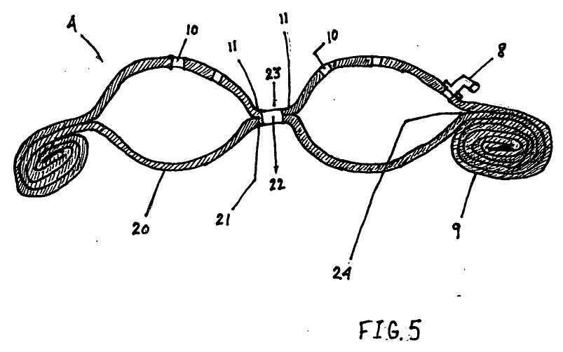

FIG. 5 shows a cross sectional view of the inflatable pad 4, taken along line 3C-3C of FIG. 3A. The air bladder material 20 is shown in two layers bonded 21 along the seam lines 11. A drain hole 23 is shown, where fluid would drain in the direction of arrow 22. The inflatable pad may channel fluid with no drain holes 23, or with one or more drain holes 23. The inflated sections of the inflatable pad 4 may leak air through low air loss holes 10. The inflatable pad 4 may be inflated through a flanged air port 8. The two or more layers of the inflatable pad 4 may be squeezed air tight 24 by rolling the washing ports 9.

I claim:

1. An inflatable incontinence bed pad comprising:
(a) an inflatable pad
(b) an absorbent pad
(c) means for channeling fluids from said inflatable pad into said absorbent pad
whereby said inflatable incontinence bed pad spreads out pressure areas of a patient and decreases surface moisture.

2. The inflatable incontinence bed pad of claim 1 wherein said inflatable pad has means to emit air.

3. The inflatable incontinence bed pad of claim 1 wherein said inflatable bed pad has means to tilt a user's hips.

4. The inflatable incontinence bed pad of claim 1 wherein said inflatable bed pad includes one or more handles.

5. The inflatable incontinence bed pad of claim 1 wherein said inflatable bed pad includes means for attaching to a patient lift.

6. The inflatable incontinence bed pad of claim 1 wherein said inflatable bed pad includes one or more ports with means to open for washing inside and which close airtight.

7. The inflatable incontinence bed pad of claim 1 wherein said inflatable bed pad includes means for inflating with a standard alternating pressure pad air pump.

8. The inflatable incontinence bed pad of claim 7 wherein means is provided to allow airflow between air hoses from said alternating pressure pad air pump.

9. The inflatable incontinence bed pad of claim 1 wherein side rails are integrated and may be removable.

10. The inflatable incontinence bed pad of claim 1 wherein said inflatable bed pad includes a cover with a low shear surface.

11. An inflatable incontinence bed pad comprising:
(a) an inflatable pad
(b) an absorbent pad
wherein said absorbent pad lays on top of said inflatable pad.

12. The inflatable incontinence bed pad of claim 10 wherein said inflatable pad has means to emit air.

13. The inflatable incontinence bed pad of claim 10 wherein said inflatable bed pad has means to tilt a user's hips.

14. The inflatable incontinence bed pad of claim 10 wherein said inflatable bed pad includes one or more handles.

15. The inflatable incontinence bed pad of claim 10 wherein said inflatable bed pad includes means for attaching to a patient lift.

16. The inflatable incontinence bed pad of claim 10 wherein said inflatable bed pad includes one or more ports with means to open for washing inside and which close airtight.

17. The inflatable incontinence bed pad of claim 10 wherein said inflatable bed pad includes means for inflating with a standard alternating pressure pad air pump.

18. The inflatable incontinence bed pad of claim 16 wherein means is provided to allow airflow between air hoses from said alternating pressure pad air pump.

19. A method of tilting the hips of a person in a bed, comprising:
(a) providing one or more inflatable pads with means for passing air into and out of,
(b) providing one or more absorbent articles above or beneath said inflatable pad(s),
(c) providing a means for inflation of said inflatable pad(s),
(d) inflating said pad(s) so that one side has a higher internal pressure than the other side, resulting in the hips of a person laying on said pad(s) being raised on one side,
whereby the hips of a person lying on said inflatable pad(s) may be tilted to one side and then the other side in repeated cycles over time.
